(19) United States
(12) Patent Application Publication
(10) Pub. No.: US 2002/0128887 A1
(43) Pub. Date: Sep. 12, 2002

(54) Method for safety compliance

(76) Inventors: Anthony L. Pizzulo III, Shelby Township, MI (US); Frank Scaramuzzino, Shelby Township, MI (US)

Correspondence Address: Philip R. Warn, Warn, Burgess & Hoffmann, PC, P.O. Box 70098, Rochester Hills, MI, 48307, US

(21) Appl. No.: 10/094,209

(22) Filed: Mar. 8, 2002

Related U.S. Application Data
(60) Provisional application No. 60/275,217, filed on Mar. 12, 2001.

(51) Int. Cl. G06F 17/60

(52) U.S. Cl. 705/7

(57) ABSTRACT

A technique for auditing a plant to ensure that it is compliant with a safety requirement, and making the plant compliant based on the audit. The audit determines whether placards and tags mounted on each machine in the plant accurately identify the power sources that need to be disconnected and locked out before maintenance can be performed on that machine. Once it is determined which machines do not comply, placards and tags are made for those machines that make the machine comply with the safety requirement. Once the facility is compliant, a user can enter changes into a web-based software system that provides continued compliance with the safety requirement as changes are made to the machines.

### CROSS-REFERENCE TO RELATED APPLICATIONS

This Application claims the benefit of the filing date of Provisional Application No. 60/275,217, filed Mar. 12, 2001, entitled “Method for Safety Compliance.”

### BACKGROUND OF THE INVENTION

1. Field of the Invention

This invention relates generally to a method for complying with a safety requirement and, more particularly, to a method for continually auditing a plant, or other manufacturing facility, to insure that the machines within the plant are compliant with a safety requirement, such as OSHA protocol 1910.147.

2. Discussion of the Related Art

To provide increased safety, OSHA protocol 1910.147, Control of Hazardous Energy, requires that written instructions be provided for each machine in a plant, or other manufacturing facility, that describe how to completely disengage the machine from any and all power sources, such as hydraulic, pneumatic and electrical power sources, before the machine can be serviced. Further, each power source connected to the machine must be “locked out” prior to being serviced for maintenance purposes or the like, so that a worker does not inadvertently connect a previously disengaged power source to the machine while it is being serviced. Typically, a device such as a clamp or the like, is used to lock out a power source. This protocol also requires that the lock out be verified.

One technique for complying with this protocol includes mounting a placard on the machine that includes a top view diagram of the machine to visually indicate the location and type of each power source. Further, tags are mounted to or near the power sources on the machine to specifically identify them. The placard also includes instructions for locking each power source out. Thus, maintenance personnel can ensure that every power source is disengaged and locked out prior to servicing the machine.

A difficulty exists with complying with this OSHA standard because many of the machines in a plant are constantly being moved, modified and changed for various reasons, such as change in space requirements, assembly line or job requirements, machine updating and performance, etc. Thus, although a placard may at one time accurately identify the location and type of each power source connected to the machine, changes to the power sources over time make the placard non-compliant with the standard. It is therefore desirable to have a system or process where continuous monitoring of the plant machines ensures compliance with this OSHA standard.

### SUMMARY OF THE INVENTION

In accordance with the teachings of the present invention, a technique is disclosed for continually auditing a plant to insure that it is compliant with a safety requirement, such as OSHA protocol 1910.147. According to one embodiment, the technique includes four phases. During a first phase, an initial plant audit is conducted to determine whether the machines in the plant are compliant, and if not, why they are not compliant. The audit determines whether placards and tags are mounted on each machine in the plant, and if so, whether they accurately identify the power sources that need to be disconnected and locked out before maintenance, or other service, can be performed on that machine. An audit report identifies those machines whose placards and tags comply, those machines with no placards and tags, and those machines with placards and tags that do not comply. Those placards that do comply are digitally photographed so that the placard information can be entered into a data base. The audit report is reviewed for customer understanding and concerns.

During a second phase, a proposal is submitted to the customer that outlines the procedure and costs necessary to provide complete plant compliance based on the initial audit. The proposal describes the services necessary for surveying the machines that do not have placards and tags to generate engineering drawings, creating new placards and tags where required, verifying procedures, installing placards and tags, and placing bar codes on the placards.

Once the plant is in compliance with the standard, then, during a third phase, a procedure is implemented for insuring that plant compliance is maintained as new machines are introduced into the plant, and old machines are modified. This procedure employs software implemented on a website accessible by the customer. When changes to a machine are made, the customer accesses the data base on the website, and provides an indication of the changes made to the machines. This information is transmitted to an independent company that then generates new placards and tags to be installed on the machines. In a final phase, additional audits are conducted on a predetermined time frame to further insure that the plant is maintained in compliance.

Additional objects, advantages and features of the present invention will become apparent from the following description and appended claims, taken in conjunction with the accompanying drawings.

### BRIEF DESCRIPTION OF THE DRAWINGS

FIG. 1 is a diagram of a placard for a machine identifying the power sources connected to the machine;

FIG. 2 is a flow chart for an engineering process for generating sketches of a machine for the placard, according to an embodiment of the present invention;

FIG. 3 is a flow chart for a graphics process for preparing drawings from the engineering sketches of the machine, according to an embodiment of the present invention;

FIG. 4 is a flow chart for a production process for making placards and tags for a machine, according to an embodiment of the present invention;

FIG. 5 is a flow chart for a method of installing the placards and tags on the machine, according to an embodiment of the present invention; and

FIGS. 6(a) and 6(b) are flow charts for a method of conducting a plant audit for insuring compliance with a safety standard, according to an embodiment of the present invention.

### DETAILED DESCRIPTION OF THE INVENTION

The following discussion of the invention directed to a technique for auditing a plant to insure that it is compliant with a safety requirement is merely exemplary in nature, and is in no way intended to limit the invention, or its application or uses. Particularly, the discussion below is for a technique for complying with OSHA protocol 1910.147. However, the invention has application for compliance with other safety standard and requirements.

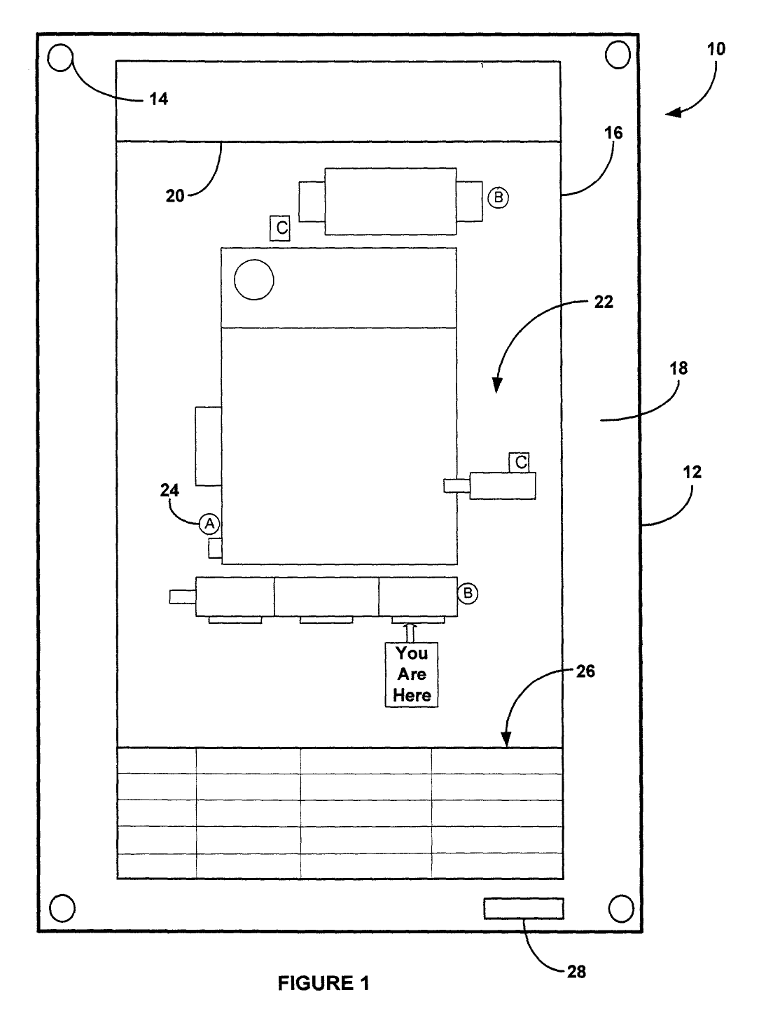

FIG. 1 is a diagram of a placard 10 representative of the type mounted to a machine or other equipment (not shown) to show the locations on the machine where the various energy and power sources are coupled thereto so that they can be “locked out” to comply with OSHA standard 1910.147. The placard 10 includes a sentra base 12 having mounting holes 14. A drawing sheet 16 is secured to the sentra base 12 by an adhesive layer and is covered with a UV protective layer 18.

The drawing sheet 16 includes a header portion 20 identifying the type of machine, and a top view diagram 22 illustrating the machine to which the placard 10 is attached. A legend “You Are Here” is shown in the diagram 22 to identify the location on the machine where the placard 10 is mounted. The diagram 22 includes a series of symbols 24 that identify the type of power source, such as electrical, pneumatic and hydraulic. A tag including the actual symbol 24 is mounted to that location on the machine to identify the power source. The tag is made the same way as the placard 10, and includes a sentra base, a diagram of the symbol 24 that is glued to the sentra base, and a UV protective layer. An information portion 26 categorizes each symbol 24 identified in the drawing, and includes various information, such as location, description, type of energy source, method of operation, method of lock out, etc. A bar code 28 is provided on the placard 10 so that the information visually indicated on the placard 10 as discussed herein can be downloaded into a data base from a bar code scanner.

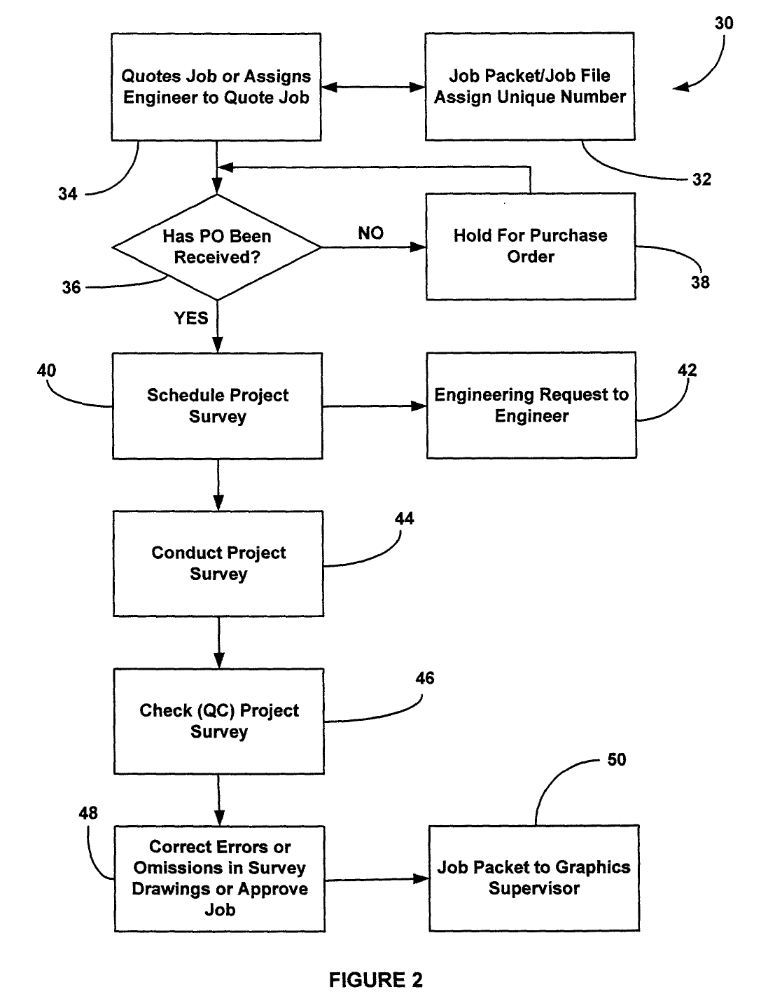

FIG. 2 is a flow chart 30 showing an engineering process for generating a sketch that will be used to draw the diagram 22, according to an embodiment of the present invention. A sales representative receives a job for making and installing one or more of the placards 10 and tags for the machines in a customer's plant or other facility, so that the machines comply with OSHA protocol 1910.147. The job may include adding placards and tags to a new machine being introduced into a plant, where the supplier is the customer. The job may include an audit, or the like, to determine which machines currently comply with the standard, and which machines do not and for what reason. The sales representative generates a job packet or job file that includes the customer's requirements for the job, and assigns a unique job number to the file at box 32.

One of the first things that the sales representative will do is determine whether the customer has an existing library of the symbols 24 that identify the particular power sources. Particularly, in order for the placards and tags to be made, it must be known whether specific symbols exist for the various power supplies and other designations so that the new placards and tags will conform thereto. If the customer does not have an existing library, then the sales representative can suggest one or more libraries from an existing data base.

An operations manager receives the job packet or job file from the sales representative and quotes the job, or assigns a qualified engineer to quote the job, at box 34. The operations manager or engineer will then determine if a purchase order (PO) or contract has been received for the job that identifies the job requirements, at decision diamond 36. If no contract has been received, then the job will be held until the contract is received at box 38. If a purchase order or contract has been received, the operations manager will check and verify the contract against the quote.

The manager will deliver the job file to an engineering supervisor to perform a project survey to generate engineering sketches of the machines for the diagram 22 at box 40. The operations manager and the engineering supervisor will coordinate and schedule qualified engineers for the project survey at box 42. The engineering supervisor, or a qualified project engineer, will make the sketches by going to the customer facility and drawing a top view of the actual machine and identify the power sources on the sketch, at box 44. The sketch will include the “You Are Here” designation for the placard. If the customer provided drawings of the machine, then the engineering sketches are unnecessary, and the operations manager will submit the drawings directly to a graphics supervisor to make the diagram 22 from the drawings, at box 50. The customer supplied drawings may have to be put in the appropriate format.

Once the engineer makes the sketches, the engineering supervisor or the qualified project engineer will check and verify that the engineering sketches are accurate at the customer's facility at box 46. If the verification reveals any non-conformances, errors or omissions in the engineering sketches, the engineer will correct and review revisions to the drawings with the engineering supervisor at box 48. The corrected sketches are then forwarded to the graphics supervisor for making the diagrams 22 at the box 50.

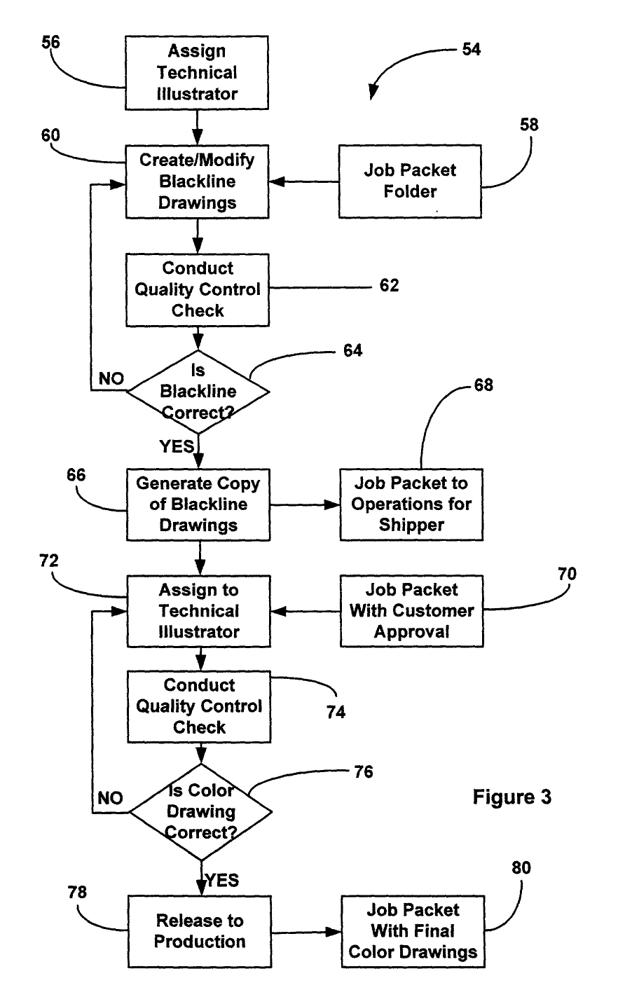

FIG. 3 is a flow chart 54 showing a method of generating the diagrams 22 from the engineering sketches or the customer provided drawings, according to an embodiment of the present invention. The graphics supervisor assigns a technical illustrator to the job after he reviews the job file at box 56. The job file is stored in a job packet folder, represented at box 58, that contains a job packet cover sheet and the engineering sketches or customer supplied drawings for all of the machines associated with the job. The technical illustrator will create blackline drawings from the engineering sketches, as indicated at box 60. The packet folder and completed blackline drawings are submitted to a quality control coordinator to perform a quality control check on the drawings at box 62. The quality control coordinator will verify the blackline drawings by comparing the drawings against the engineering sketches, or customer supplied drawings, and the customer requirements. The quality control coordinator will generate a QC checklist identifying the customer requirements, and will not “sign off” that the blackline drawings are correct until all items are marked, as indicated as decision diamond 64. If the quality control coordinator finds a problem with the blackline drawings, the drawings are returned to the technical illustrator for modifying at the box 60.

If and when the blackline drawings are correct, the quality control coordinator will sign off on the job and return the job packet to the technical illustrator. The technical illustrator will then make a photocopy of the blackline drawings and place the copy in the job packet folder at box 66. The original blackline drawings will be prepared for customer review and a blackline shipper will be generated at box 68. The customer will review the blackline drawings, and return the drawings to the job packet folder with approval or revisions at box 70.

The graphics supervisor receives the job packet with customer approval or revisions, and assigns a technical illustrator to make revisions and/or generate color versions of the blackline drawings, at box 72. The quality control coordinator will verify accuracy of the color drawings by comparing the drawings against the engineering sketches, or customer supplied drawings, and the contract requirements, as indicated at box 74. The quality control coordinator will perform a quality control check for accuracy of the color drawings at decision diamond 74, and will not sign off until all items are marked. If the quality control coordinator finds problems with the color drawings, they are returned to the technical illustrator at box 72 for corrections. If the color drawings are correct, the job packet folder and completed color drawings are released to the production department to make the placards and the tags at box 78. The final color drawings are then put in the job packet folder at box 80.

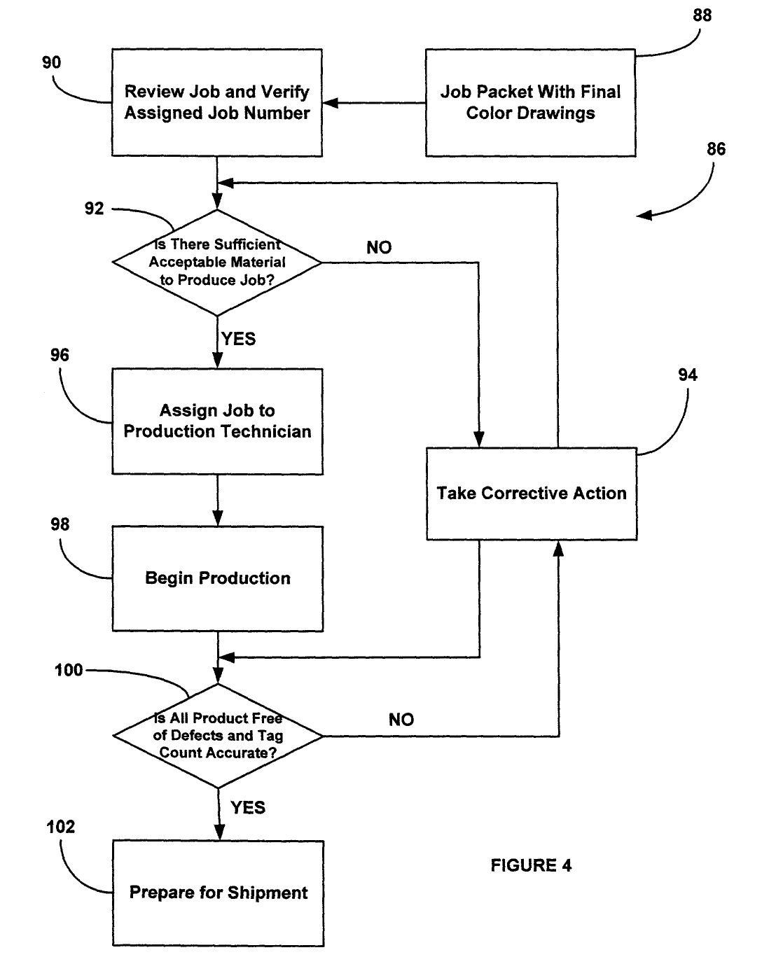

FIG. 4 is a flow chart 86 for producing the placards and the tags for the job, according to the invention. The job packet folder with the final color drawings is provided to a production supervisor at box 88. The production supervisor will verify that the job has a unique job number, the job skill required, the content required and the materials required to make the placards and the tags at box 90. The production supervisor will then verify that all materials required to make the placards and the tags according to the contract requirements are in stock and free of defects, at decision diamond 92. If the necessary materials are not in stock or the materials in stock do have defects, then the production supervisor will take the necessary corrective action at box 94.

If and when the materials are in stock and are free of defects, the production supervisor will approve the job for production of the placards and the tags, and will assign the job to a production technician at box 96. The assigned technician will make the placards and the tags based upon the skill and specifications stated in the contract requirements at box 98. The technician will cut the pieces of the sentra base 12, form the mounting holes 14, secure the drawing sheet 16 to the sentra base 12 with the adhesive, and then cover the entire front of the sentra base 12 with the protective layer 18. Once the placards and the tags have been produced, the production technician will verify the integrity of the placards and the tags and check the tag count at decision diamond 100. If the final product is not free of defects, or the tag count is inaccurate, the production technician will take the necessary corrective action at the box 94. If the final product is free of defects and the tag count is accurate, then the production technician will sort, tag and package the completed job for shipment at box 102.

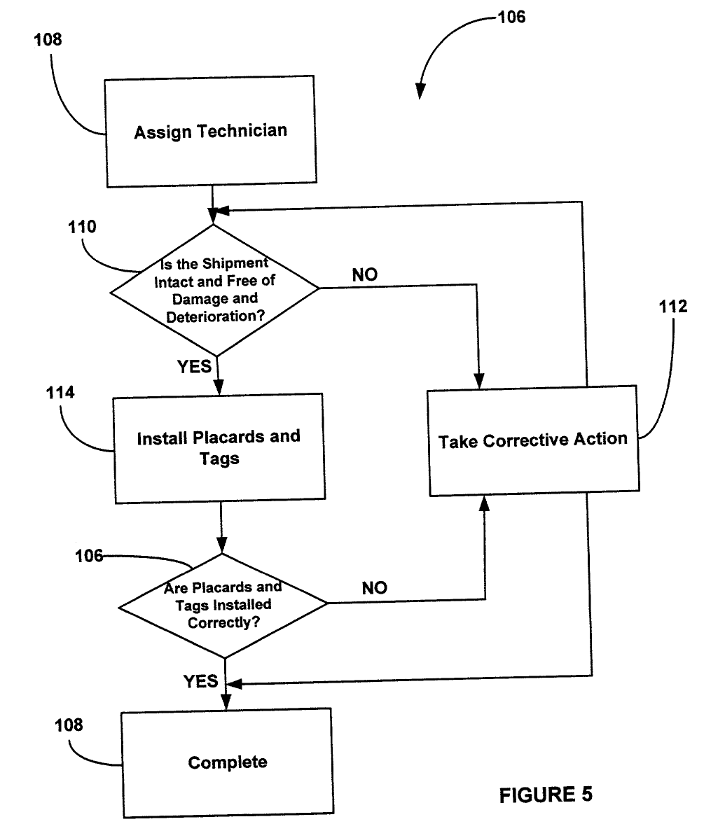

FIG. 5 is a flow chart for installing the placards and the tags on the machines at the customer's facility. The production supervisor assigns a production technician to travel to the customer's facility for the purpose of installing the placards and the tags on the machines at box 108. When the customer receives the placards and the tags, the production technician will verify that they are intact and free of damage and deterioration consistent with the contract requirements at decision diamond 110. If the shipment is not intact and free of damage and deterioration, the production technician will take the necessary corrective action at box 112.

Once the shipment is intact and free of damage and deterioration, the production technician will install the placards and the tags on the machine at the “You Are Here” location consistent with the customer's requirements at box 114. Prior to leaving the customer's facility, the production technician will verify that the placards and the tags have been properly and securely installed, the tag count is correct and that the placards match the actual appearance of the machine at decision diamond 96. If the placards and the tags have not been installed correctly, the production technician will take the necessary corrective action at the box 112. If the placards and tags have been installed correctly, the production technician's duties at the customer's facilities are complete at box 118.

The discussion above concerns generating placards and tags for a machine or machines in a plant to make the machine and plant compliant with OSHA protocol 1910.147. In some situations, the machines in a plant did at one time comply with this standard, but for various reasons may not currently be compliant with the standard. Therefore, a need exists to determine which machines are currently non-compliant, correct those non-compliant machines and provide a continuous process of insuring future compliance.

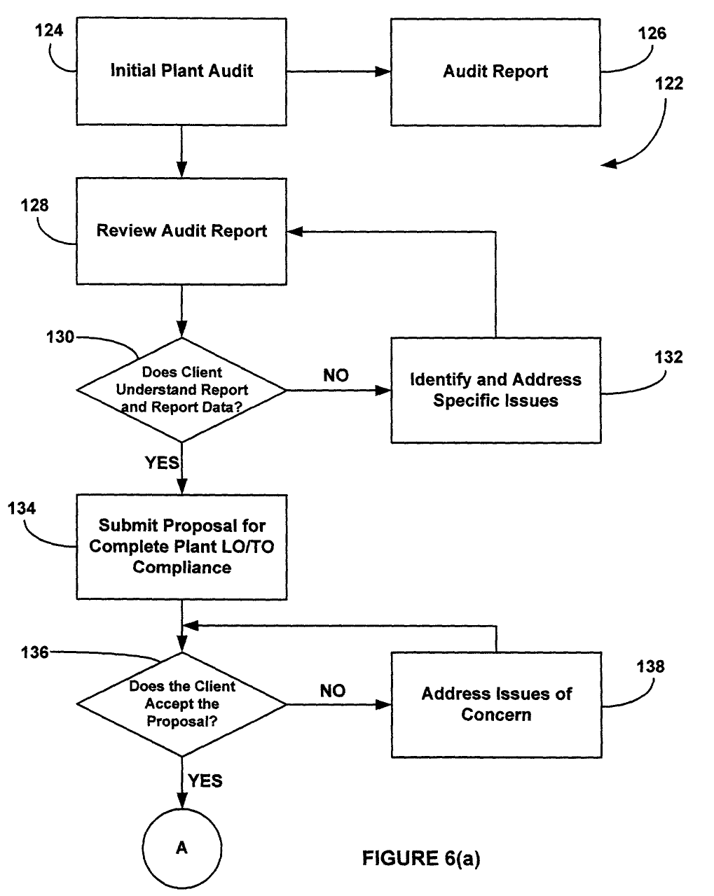

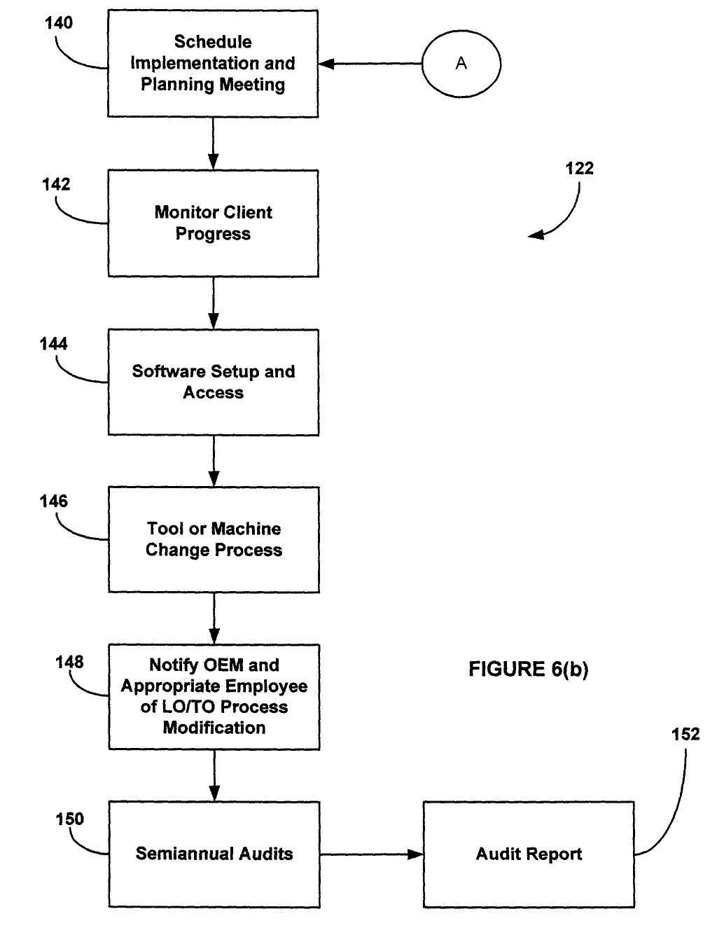

According to the invention, FIGS. 6(a) and 6(b) show a flow chart 122 of a process for auditing a plant by an independent company, such as Premier Autoworkers, Inc. of Troy, Mich., for compliance with this OSHA standard, correcting those occurrences of non-compliance, and providing continuous auditing of the plant for continued compliance. During a first phase, an initial plant audit is conducted of the plant or facility at box 124 to determine the current state of compliance of the machines. An audit report is generated at box 126 that specifically identifies each machine in the plant and its compliance, including the placement of the placards and tags on the machine, if they exist, and whether the placards and tags are accurate, and if not, why are they not accurate.

Each piece of equipment or machine is inspected for the correct lock out/tag out (LO/TO) placards and tags. All existing placards that are in compliance based on the customer's standards are equipped with a bar code sticker for identification purposes. Placards that are in compliance are digitally photographed so that the information thereon can be entered into a data base. The audit report includes information on the machines whose placards and tags comply, machines with no placards and tags, and machines with placards and tags that do not comply. The safety department for the customer will be notified for those placards that do not comply and non-conforming stickers can be applied to those placards.

The audit report is then reviewed at box 128 to ensure that there is a complete understanding of the report data at decision diamond 130. If the customer does not understand any part of the report or the report data, then the specific issues will be identified and addressed at box 132.

During a second phase of the process, a proposal is submitted for providing a complete plant LO/TO by the independent company compliance at box 134 based on the original audit. The proposal report will include services for surveying the machines that do not have placards and tags to generate engineering sketches creating new placards and tags where required, verifying procedures, installing placards and tags on the machines and placing a bar code on the placards, in the manner discussed above for the flow charts 2-5. Once the compliance proposal has been completed, it is determined whether the customer accepts the proposal at decision diamond 136. If the customer does not accept the proposal, then the client concerns are addressed at box 138. Once the customer does accept the proposal and a purchase order is received for the services to bring the plant into compliance, a project implementation and planning meeting is scheduled at box 140 to discuss how that will be done and the appropriate time frame. Compliance progress is monitored at box 142 to determine when the engineering sketches are completed, when the customer is shipped the blackline drawings and when the placards and tags have been received and/or installed.

Once the plant has been brought into compliance, then the customer and the independent company coordinate to maintain compliance during a third phase of the process. The present invention proposes a website employing software so that the customer can access the various files and data bases associated with the placards and tags for each machine. At box 144, software setup and access is performed by the independent company and designated customer personnel are trained to use the system software.

At box 146, the appropriate personnel will develop and implement a process to notify the appointed personnel of machine changes and all pertinent information. At box 148, the customer will notify all OEMs and appropriate plant personnel that new equipment LO/TO electronic files need to be sent to the customer.

The website software allows the customer to access and update the machine files to maintain compliance of the machines in the plant. According to one embodiment of the present invention, the customer logs into the software via the internet to access the data base and files. The customer checks a drawing out of the data base, and enters the “edit drawings” section of the data base. The customer makes annotations or changes to the drawings based on changes made to the machine, and clicks on the send button. The software then contacts the independent company to let them know that a machine file has been annotated. The software then returns the drawing to the data base, and logs the change into the appropriate file to keep a running history.

The independent company's graphics team then makes the requested changes to the drawing and uploads the changes back into the data base. The software logs the drawing into the “verification” section, and sends the customer an e-mail stating that the file has been uploaded and needs verification before the new placard can be created. The customer then logs back into the software and navigates to the verification section to check that the drawing is accurate. If the personnel verifies that the drawing is complete and accurate, he clicks on the “verify” button. This sends a notification to the independent company that the drawing has been verified and to proceed with production of the new placard. At the same time, the software would again update the file to reflect the latest change and keep a running history. If the personnel rejects the drawing, he will have a chance to again annotate the drawing and send it back to the independent company. The software will log this activity to keep a running history. Once the drawing has been verified and created, the data base will have a complete record of all communications between the independent company and the customer.

During phase four, continuous audits by the independent company, such as semi-annual audits, are conducted at box 150. The audit team will use hand held data collection terminals, such as PDAs, with attached bar code scanners to verify that all placards within the facility are compliant. The software includes drop-down menus identifying various information that can be accessed and entered, such as plant identification, company name, various company departments, bar code scanning, machine type, number and location, machine tag names and status, reasons for non-compliance, etc. The data will then be downloaded into a program for tracking purposes. An audit report 152 is generated and submitted to the client. Thereafter, the customer will perform the semiannual audits and assume control of the LO/TO audit process.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method of determining whether machines in a facility are compliant with a safety requirement, making the machines compliant with the safety requirement, and maintaining compliance with the safety requirement over time, comprising:
performing a facility audit to determine which machines in the facility comply with the requirement, which machines do not comply with the requirement, and why those machines don't comply with the safety requirement;
submitting a proposal for making the machines in the facility compliant based on the audit;
making the machines in the facility compliant with the safety requirement; and
monitoring the facility once the machines are compliant to ensure that the machines are maintained in compliance with the safety requirement.

2. The method according to claim I wherein performing a facility audit includes determining whether a machine includes a placard identifying power sources coupled to the machine, and whether the placard accurately identifies all of the power sources.

3. The method according to claim 2 wherein performing a facility audit includes placing a bar code sticker on the placard of a machine that is compliant.

4. The method according to claim 2 wherein performing a facility audit includes digitally photographing the placard on a machine that is compliant so that information on the placard can be entered into a data base.

5. The method according to claim 1 wherein performing a facility audit includes reviewing an audit report with the customer to address any customer concerns or issues.

6. The method according to claim 1 wherein submitting a proposal includes identifying the costs and time frame necessary to make the machines in the facility compliant.

7. The method according to claim 6 wherein submitting a proposal includes identifying services for generating engineering sketches of those machines that do not have placards and tags, creating drawings of the machine from the engineering sketches, creating placards and tags that include the drawings and installing the placards and tag s on the machines.

8. The method according to claim 1 wherein making the facility compliant includes generating engineering sketches of those machines that do not have placards and tags, creating drawings of the machine from the engineering sketches, creating placards and tags that include the drawings and installing the placards and tags on the machines.

9. The method according to claim 1 wherein monitoring the facility includes providing a web-based software system that allows a user to access a facility data base to make changes to drawings associated with machines in the data base when changes to the machines are made.

10. The method according to claim 9 wherein accessing the data base includes forwarding the information to an independent company that generates new placards and tags based on the changes.

11. The method according to claim 1 wherein maintaining facility compliance includes conducting future audits of the facility to ensure compliance.

12. The method according to claim 11 wherein the audits are conducted using a hand-held unit that includes software that allows information concerning the compliance of the machines to be entered into the unit.

13. The method according to claim 12 wherein the unit includes a bar code scanner for scanning a bar code on a placard on the machine.

14. A method of determining whether machines in a facility are compliant with a safety requirement, making the machines compliant with the safety requirement, and maintaining compliance with the safety requirement over time, comprising:
performing a facility audit to determine which machines in the facility comply with the requirement, which machines do not comply with the requirement, and why those machines don't comply with the requirement, wherein performing the facility audit includes determining whether a machine includes a placard and tags identifying power sources coupled to the machine, and whether the placard accurately identifies all of the power sources;
submitting a proposal for making the machines in the facility compliant based on the audit, wherein submitting a proposal includes identifying services for generating engineering sketches of those machines that do not have placards and tags, creating drawings of the machine from the engineering sketches, creating placards and tags that include the drawing and installing the placards and tags on the machines;
making the machines in the facility compliant with the safety requirement including generating the engineering sketches of those machines that do not have placards and tags, creating drawings of the machine from the engineering sketches, creating placards and tags that include the drawings, and installing the placards and tags on the machines; and
monitoring the facility once the machines are compliant to ensure that the machines are maintained in compliance with the safety requirement, wherein monitoring the facility includes providing a web-based system that allows a user to access a facility data base on the web to make changes to drawings associated with machines in the data base when changes are made to the machines.

15. The method according to claim 14 wherein performing a facility audit includes placing a bar code sticker on the placard of a machine that is compliant.

16. The method according to claim 14 wherein performing a facility audit includes digitally photographing the placard on a machine that is compliant so that information on the placard can be entered into a data base.

17. The method according to claim 14 wherein accessing the data base includes forwarding information to an independent company that generates new placards and tags based on the changes.

18. The method according to claim 14 wherein the audits are conducted using a hand-held unit that includes software that allows information concerning the compliance of the machines to be entered into the unit.

19. The method according to claim 18 wherein the unit includes a bar code scanner for scanning a bar code on a placard on the machine.

20. The method according to claim 14 wherein maintaining facility compliance includes conducting future audits of the facility to ensure compliance.

21. A method of making machines in a facility compliant with a safety requirement, and maintaining compliance with the safety requirement over time, comprising:
determining which machines in the facility comply with the requirement, which machines do not comply with the requirement, and why those machines don't comply with the safety requirement;
making the machines in the facility compliant with the safety requirement; and
monitoring the facility to ensure that the machines remain compliant with the safety requirement, wherein monitoring the facility for compliance includes providing a web-base software system that allows a user to access the web to identify changes made to the machines in the facility.

22. The method according to claim 21 wherein making the facility compliant includes placing a bar code sticker on a placard of a machine that is compliant.

23. The method according to claim 21 wherein determining which machines comply includes digitally photographing a placard on the machine that is compliant so that information on the placard can be entered into a data base.

24. The method according to claim 21 wherein making the facility compliant includes generating engineering sketches of those machines that do not have placards and tags, creating drawings of the machine from the engineering sketches, creating placards and tags that include the drawings and installing the placards and tags on the machines.

25. The method according to claim 21 wherein accessing the web includes forwarding the information to an independent company that then generates new placards and tags based on the changes.

26. The method according to claim 21 further comprising conducting audits of the facility to ensure compliance.

27. The method according to claim 26 wherein the audits are conducted using a hand-held unit that includes software that allows information concerning the compliance of the machines to be entered into the unit.
